(19) United States
(12) Patent Application Publication
(10) Pub. No.: US 2003/0173462 A1
(43) Pub. Date: Sep. 18, 2003

(54) Spaceshuttle launched observatory

(76) Inventor: Zoltan Herpay, London (GB)

Correspondence Address: Dr. Zoltan Herpay, 28 Dudley Court, 36 Endell Street, London, WC2H 9RD, GB

(21) Appl. No.: 10/100,729

(22) Filed: Mar. 18, 2002

(51) Int. Cl. B64G 1/22; B64G 1/00

(52) U.S. Cl. 244/158 R

(57) ABSTRACT

A Spaceshuttle launched observatory is hidden in the fuselage of the shuttle in lift up at the top, but being a third tubular body, it is pulled out, as the large central fuel tank is slipping outwardly towards the tail, pulling down the secondary to the botton of the telescope tube, as the fuel tank goes, both the telescope-observatory and fuel tank of the central fuselage comes out, leaving the seemingly empty lift-up shuttle body, whose frontal fuselage could accommodate cockpits for a number of space travellers, interested about a few circlings and in the reentry, however, after a long time of refilling the same could be launched again with a new observatory and crew, and when these are positioned out, the shuttle could rescue the old observatory and bring it bach, making its new travellers richer with the experience of fishing back the old observatory.

This invention relates to a Speceshuttle launched observatory and more particularly refers to a large space-observatory and telescope which could be rescued back to earth by the same spaceshuttle, which launched it.

Spaceshuttles and space-telescopes are known by everybody in the part-systems seeking antisynergetic scientific world, but the integrated use of them requires a synergetic attention, for it is clear that space-reseach have to be extended towards a better observational astronomy with some minor local travellings, for suitable planets for grand-scale escapings from the major problems at home on the earth could not be planned yet because not a single one is well observational. No observational facts are supporting any of our leading cosmological theories. The 99.99 percent of the so called Observational Universe is still non-observational, yet it is also clear that life is created out there continuously and pumped towards us implosively.

According to the present invention there is provided a Spaceshuttle launched and rescued observatory, in which the spaceshuttle is a self-lifting body, capable of transporting its own crew and travelling passengers, having a multi-ringed fuselage, in which the outer and the inner fuel tanks are sandwiching a third tubular body, the telescope and its observatory at its top end, but as the central fuel tank slides outwardly towards the tail, first it pulls down the small secondary reflector to the lower end of the telescope tube, than it pulls the whole telescope out, from which it is separating itself in space. The only jettisoned object is this central fuel tank and its tail-engine when it is empty. The body of the spaceshuttle and its “population” goes away for a few circlings, but the telescope-observatory have to open out from its outer tubular part two wing-like radiation collectors, capable of turning around the telescope as well as around the axis of their side roots. In this case no surface areas of the observatory are covered with ablation layers. The cylindrical ring of the observatory holds a large amount of fuel for the powering of its controlling auxiliary engines (not shown), yet still its inner space is big enough for housing a number of observatory crew, behind a large main reflector, crucial for collecting large amount of new observational facts, transmitting the same back to the earth, and it could do this for a considerable period of time with a permanently controlled main reflector, which could also be a major shield for the crew, if required. In the time of rescuing, its “wings” are released, its back part is directed back into the empty fuselage of a rescuing spaceshuttle which could bring it back to earth without the need for any military actions.

A specific embodiment of the invention will now be described by way of example with reference to the accompanying drawing in which:

FIG. 1 shows the top planar view of cross-section of the spaceshuttle with the observatory and its telescope together with its central fuel tank and engine, as it is before lift-up or in lift up.

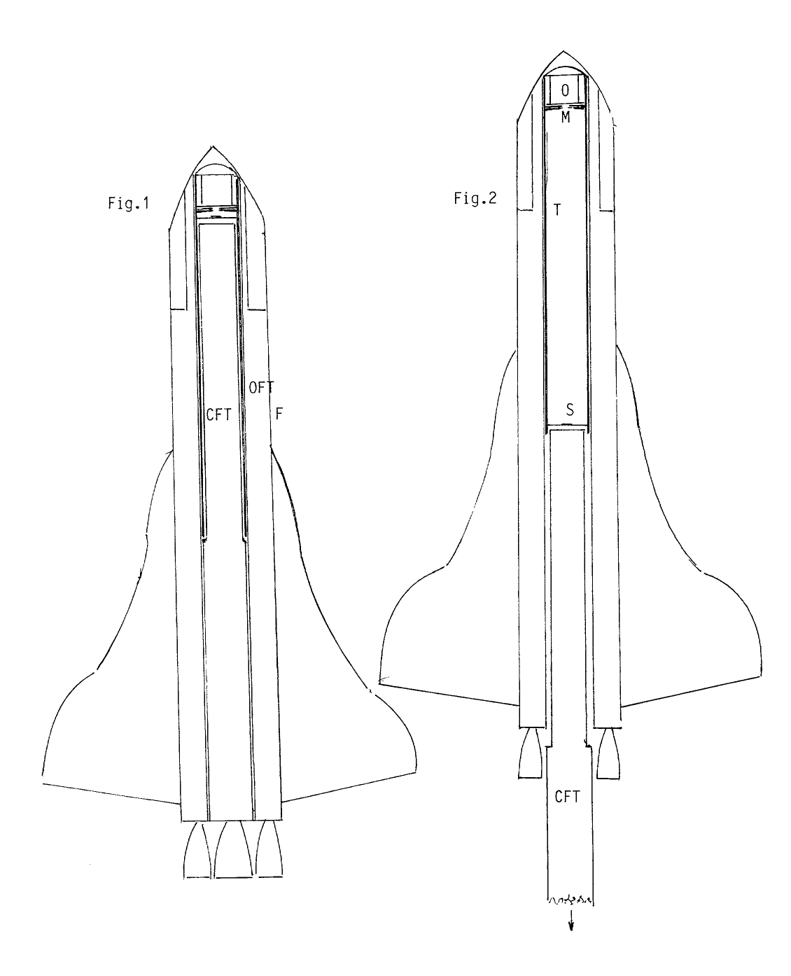

FIG. 2 shows the first outward movement of the central fuel tank, as it is pulling down the secondary reflector into position with its slightly narrower tubular body.

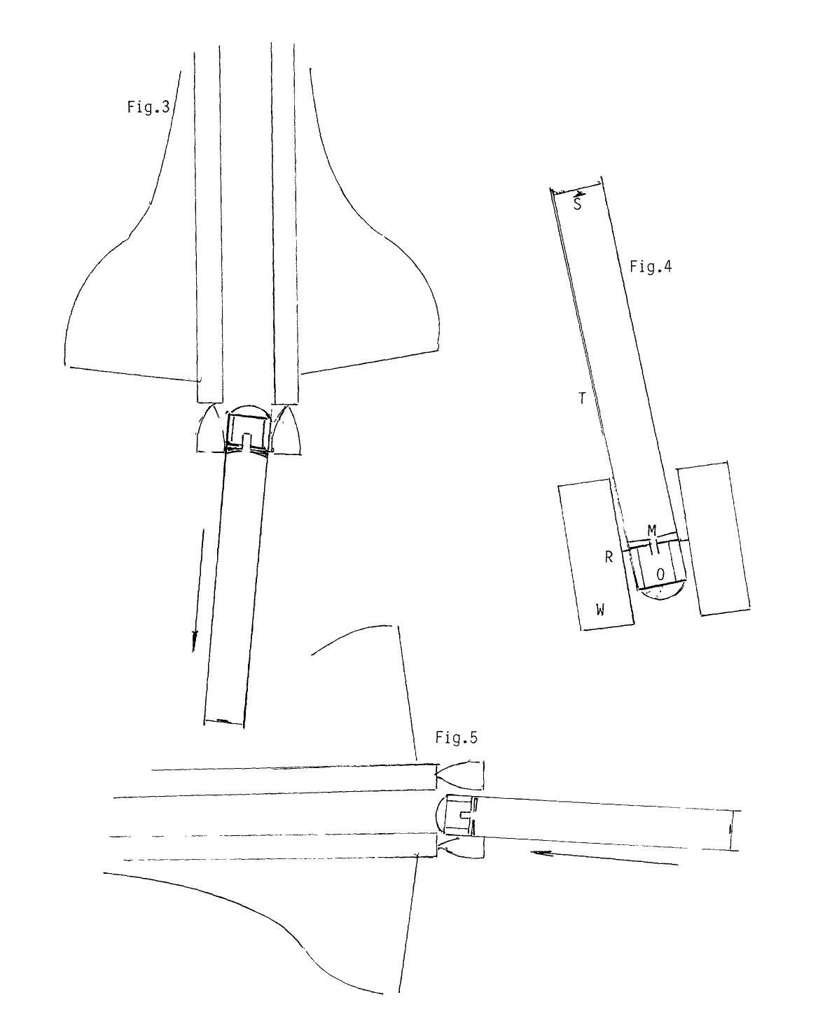

FIG. 3 shows the second outward movement of the central fuel tank, when it starts to pull the whole telescope tube with its observatory part entirely out from the fuselage of the spaceshuttle. (The lowest part of the central fuel tank with its engine is not shown.)

FIG. 4 shows the entirely free telescope and its observatory in space, as it is erecting two large wing-like area out from its outer surface for collecting solar radiation.

FIG. 5 shows the rescue operation, as the observatory and telescope is power-pushed back to the rescuing empty fuselage of the of a spaceshuttle before re-entry.

Referring to FIG. 1 the capital letters F=fuselage, OFT=outer fuel tank, O=observatory, M=main reflector, T=tubular telescope, S=secondary, IFT or CFT=inner fuel tank or central fuel tank. (The telescope tube and observatory is shown with strong lines. The thickness of the central fuel tank at the top is slightly narrower for it is inside the telescope.)

Referring to FIG. 2 the narrower central fuel tank pulls down the secondary reflector S into position and it starts to pull the telescope-observatory out.

Referring to FIG. 3 the pulling out of the whoe observatory and telescope is completed and the central fuel tank disappears.

Referring to FIG. 4 the telescope-observatory erects two side-wings W1 and W2 from a centrally positioned ring R on two side pins P. The ring could rotate aronud the telescope tube, the wings could rotate on the pins. Befor rescuing these wings are released and jettisoned.

Referring to FIG. 5 the old spaceshuttle reappears with its empty central fuselage and the observatory-telescope is directed back to it before reentry.

The dimensions could be reckoned from a single information if the diameter of the main reflector M is 5 meters.

The design as a whole is tanergetic. It is based on several scientific facts; for example, on the fact that the making of ultralight reflectors is relatively easy, and the maintaining their shape thermally is also possible.

1. A Spaceshuttle launched and rescued observatory comprising a large self-lifting spaceshuttle with a multi-layered fuselage, in which the observatory and its telescope-tube are sandwiched between the outer and the inner fuel-tank and in the process of lift-up the central fuel tank is holding the secondary reflector very close to the main reflector, but when it is slipping out towards the tail, first it is positioning the secondary at the lower end of the telescope, then it is pulling the whole telescope and observatory out, but in the rescue the observatory could be powered back into the same fuselage.

2. A Spaceseshuttle launched and rescued observatory as claimed in claim 1 in with both the observatory and the spaceshuttle are manned, but the latter might accommodate small rooms for special travellers, who are ready to come back after a few circlings to tha earth, while the crew of the observatory is remaing in space for a longer period of time.

3. A Spaceshuttle launched and rescued observatory as claimed in claim 1 and 2 whose only jettisoned part is the central fuel tank and its main engine when it is burned out and pulled the observatory out from the fuselage.

4. A Spaceshuttle launched and rescued observatory as claimed in any of the previous claims whose spaceshuttle could do its reentry either with the observatory or without the observatory.

5. A Spaceshuttle launched and rescued observatory as claimed in any of the previous claims, whose observatory is built with its main reflector at one side into the tubular body of a telescope, has its double walled cylindrical side for storing fuel, and it can erect its own double winged solar-radiation collectors, both rotatable in two ways, and both jettisonable berore rescue.
